(19) United States
(12) Patent Application Publication
(10) Pub. No.: US 2005/0245425 A1
(43) Pub. Date: Nov. 3, 2005

(54) Dry neutralisation method II

(76) Inventors: Bernhard Orlich, Duesseldorf (DE); Gerhard Blasey, Duesseldorf (DE); Hans-Friedrich Kruse, Korschenbroich (DE); Wilfried Raehse, Duesseldorf (DE)

Correspondence Address: HENKEL CORPORATION, THE TRIAD, SUITE 200, 2200 RENAISSANCE BLVD., GULPH MILLS, PA, 19406, US

(21) Appl. No.: 11/148,825

(22) Filed: Jun. 9, 2005

Related U.S. Application Data
(63) Continuation of application No. PCT/EP03/13613, filed on Dec. 3, 2003.

(30) Foreign Application Priority Data
Dec. 12, 2002 (DE) 102 58 006.5

(51) Int. Cl. C11D 17/00

(52) U.S. Cl. 510/444

(57) ABSTRACT

A process for making detergent granules having a bulk density of 300 to 700 g/l. A solid carrier containing neutralizing agent is mixed in a rotating mixer with a liquid binding agent containing surfactant acid to forma partially granulated premixture. The premixture is fluidized, sprayed with additional binder, and granulated in a fluidized bed reactor to form the detergent granules.

### CROSS REFERENCE TO RELATED APPLICATIONS

This application is a continuation under 35 U.S.C. § 365(c) and 35 U.S.C. § 120 of international application PCT/EP2003/013613, filed on Dec. 3, 2003. This application also claims priority under 35 U.S.C. § 119 of DE 102 58 006.5, filed Dec. 12, 2002, which is incorporated herein by reference in its entirety.

### BACKGROUND OF THE INVENTION

The present invention relates to a process for manufacturing surfactant granules. In particular, it relates to a process, which allows the cost optimized manufacture of easily soluble surfactant granules or laundry and cleaning product compositions.

Although the commercial synthesis of light-colored anionic surfactants is now technically well understood, technical application problems arise in manufacturing and processing such surfactants. In the course of the manufacturing process, the anionic surfactants are present in their acid form and must be converted with suitable neutralization agents into their alkaline or earth alkaline metal salts.

This neutralization step can be carried out with alkali hydroxide solutions or even with solid alkali substances, particularly sodium carbonate. Neutralization with aqueous alkalies yields the surfactant salts in the form of aqueous preparation forms, in which the water contents are adjustable from about 10 to 80 wt. % and particularly in the range from about 35 to 60 wt. %. Products of this type have a pasty to cuttable consistency at room temperature, the flowability and pumpability of such pastes being reduced or even zero, already in the range of about 50 wt. % active substance, with the result that considerable problems occur on the further processing of such pastes, particularly on mixing them into solid mixtures, for example in solid laundry and cleaning products. Consequently, there has always been the need to be able to provide the anionic detergent surfactants in a dry, especially a free-flowing form. In fact, customary drying technology, for example in a spray tower, also enables the production of free-flowing anionic surfactant powders or granules, especially those from fatty alcohol sulfates (FAS). However, there are serious limitations here, as the resulting preparations are often hygroscopic; by absorbing water from the atmosphere during storage they form clumps and also have a tendency to clump in the finished detergent. Because of the required high water content of the pastes processed in the spray tower, the energy consumption for this type of spray process is correspondingly high.

An alternative to spray-drying surfactant pastes is granulation. In the patent literature there is also a broad prior art on the non-tower manufacture of laundry and cleaning products. Many of these processes start with the acid form of the anionic surfactant, as this class of surfactant quantitatively represents the greatest part of wash-active substances and the anionic surfactants exist in the form of free acids in the course of their production process and must be neutralized to the corresponding salts.

The European Patent application EP-A-0 678 573 (Proctor & Gamble) describes a process for the manufacture of free flowing surfactant granules having a bulk density of at least 600 g/l, in which anionic surfactant acids are reacted with an excess of neutralizing agent to form a paste with a total surfactant content of at least 40% by weight; mixing said paste with one or more powders wherein at least one of the powders must have been spray dried and comprises anionic polymer and cationic surfactant, the resulting granular product being optionally dried. This document indeed reduces the proportion of spray-dried granules in the laundry and cleaning products, avoiding spray-drying, although not completely.

The European Patent application EP-A-0 438 320 discloses a batch process for the manufacture of surfactant granules with bulk densities above 650 g/l. Here, a solution of an alkaline inorganic material in water is treated with the anionic surfactant acid, together with the possible addition of other solids, and granulated with a liquid binder in a high-speed mixer/granulator. Neutralization und granulation take place in the same apparatus, but in separate process steps, such that the process may only be run in a batch mode.

A continuous neutralization/granulation process for the manufacture of FAS and/or ABS granules from the acid is known from European Patent application EP-A-0 402 112 (Proctor & Gamble), in which the ABS acid is neutralized with an at least 62% NaOH solution and is then granulated, after the addition of auxiliaries, for example ethoxylated alcohols or alkyl phenols or a polyethylene glycol with a melting point greater than 48.9° C. and a molecular weight between 4000 and 50 000.

The European Patent application EP-A-0 508 543 (Proctor & Gamble) cites a process in which a surfactant is neutralized with an excess of alkali to an at least 40 wt. % surfactant paste, which is subsequently conditioned and granulated, in which a direct cooling with dry ice or liquid nitrogen is made.

Dry neutralization processes, in which sulfonic acids are neutralized and granulated, are disclosed in EP 555 622 (Proctor & Gamble). According to this document, the neutralization of the anionic surfactant acids is carried out in a high-speed mixer with an excess of finely divided neutralization agent having a mean particle size below 5 μm.

A similar process that is also carried out in a high-speed mixer and in which 2 to 20 μm ground sodium carbonate serves as the neutralization agent, is described in WO98/20104 (Proctor & Gamble).

Surfactant mixtures, which are subsequently sprayed onto solid absorbants, affording detergent compositions or components therefor, are also described in EP 265 203 (Unilever). The liquid surfactant mixtures disclosed in this publication comprise sodium or potassium salts of alkylbenzene sulfonic acids or alkyl sulfonic acids in amounts up to 80 wt. %, ethoxylated nonionic surfactants in amounts up to 80 wt. % and maximum 10 wt. % water.

Similar surfactant mixtures are also disclosed in the earlier EP 211 493 (Unilever). This document teaches sprayable surfactant mixtures comprising between 40 and 92 wt. % of a surfactant mixture as well as more than 8 to a maximum of 60 wt. % water. The surfactant mixture itself consists of at least 50% polyalkoxylated nonionic surfactants and ionic surfactants.

A process for the manufacture of a liquid surfactant mixture from the three constituents, anionic surfactant, nonionic surfactant and water, is described in EP 507 402 (Unilever). Here, the disclosed surfactant mixtures, which should comprise little water, are manufactured by bringing together equimolar quantities of neutralizing agent and anionic surfactant acid in the presence of nonionic surfactant.

The German Offenlegungsschrift DE-A42 32 874 (Henkel KgaA) discloses a process for the manufacture of laundry and cleaning active anionic surfactant granules by the neutralization of anionic surfactants in their acid form. Here, the neutralization agents are disclosed as solid materials in powder form, particularly sodium carbonate, which reacts with the anionic surfactant acids to anionic surfactants, carbon dioxide and water. The resulting granules have surfactant contents around 30 wt. % and bulk densities below 550 g/l.

The European application EP 642 576 (Henkel KgaA) describes a two-step granulation in two in-line mixers/granulators, wherein in a first low speed granulator, 40-100 wt. % of the solid and liquid constituents, based on the total amount of constituents, are pre-granulated, and in a second, high speed granulator, the pregranule is mixed, optionally with the remaining constituents, and converted into a granule.

In the European Patent EP 772 674 (Henkel KgaA), a process for the manufacture of surfactant granules by spray drying is described, in which anionic surfactant(s) and highly concentrated alkaline solutions are separately treated with a gaseous medium, mixed in a multi-component nozzle and neutralized, and spray-dryed by spraying in a hot gas stream. The fine-particle surfactants resulting from this process are subsequently agglomerated in a mixer into granules with a bulk density of greater than 400 g/l.

The German Offenlegungsschrift DE-A-43 14 885 (Süd-Chemie) discloses a process for the manufacture of laundry and cleaning active anionic surfactant granules by neutralization of the acid form of the anionic surfactant with an active base compound, wherein the hydrolysis-sensitive acid form is converted into a hydrolysis-sensitive anionic surfactant with the neutralization agent, without the liberation of water. Preferably, sodium carbonate is added as the neutralization agent, which reacts in this process to form sodium hydrogen carbonate.

The present invention was based on the object of providing a continuous process, which permits laundry and cleaning products to be manufactured without or with reduced use of spray-drying steps. In addition, a further cost optimization should be achieved in comparison to the disclosed processes of the prior art. Accordingly, the provided process should also enable the direct and economically attractive processing of the acid forms of detergent raw materials, avoiding, as far as possible, the disadvantages of the energy-intensive water evaporation or the use of energy-intensive high-speed mixers or high-shear mixers.

At the same time, the bulk densities of the manufactured granules should be able to be varied within wide limits, a particular aim of the present invention being that of obtaining the low bulk densities of customary spray-dryed products, also by means of a non-tower process. In particular, a specific process control should enable the end products to be superior to products manufactured according to processes of the prior art, the bulk density of the end products, in particular, should be able to be adjusted by means of the process control. In addition, the end products of the process according to the invention should have a high solubility.

It has now been determined that easily soluble surfactant granules with a low bulk density and excellent solubility profile can be manufactured if the reaction of the anionic surfactant acids with the neutralizing agent sodium carbonate is effected in a two-step process using a rotating reactor. The use of the rotating reactor thereby allows not only the bulk densities of the reaction products to be varied in a controlled manner, but the reaction can also be controlled in such a way that the added sodium carbonate at least partially reacts to form sodium hydrogen carbonate. The resulting reaction products are characterized by a specific carbonate/hydrogen carbonate ratio.

The subject of the present invention is a process for manufacturing detergent granules with a bulk density between 350 and 700 g/l, comprising the steps:
mixing a solid carrier material with a first portion of a liquid binding agent in a premixer;
transferring the resulting partially granulated mixture into a fluidized bed reactor and fluidizing this mixture to form a fluidized bed;
spraying a second portion of a liquid binding agent by means of a spray device, onto the fluidized bed formed in the fluidized bed reactor, and further granulation,
wherein the premixer is a rotating reactor.

Characterizing for the process according to the invention is the use of a rotating reactor for mixing the solid carrier material and a first portion of a liquid binding agent in the first step of the process. In the context of the present invention, “rotating reactors” are such mixers, which are characterized by a moving or rotating reactor body, or a moving mixer body. These types of reactors can also have static and/or moving mixing and/or cutting tooling. However, preferred rotating reactors are those, in which the mix is raised by wall friction and subsequently falls freely through the mixer volume due to its own weight.

Preferred “rotating reactors” are gravity mixers. Suitable vessels of such gravity mixers are those with simple geometrical shapes (inter alia cylinders, simple or double cones, cubes). Preferred mixing vessels have preferably obtuse-angled inner corners, as by this means both the free movement of the mix and the emptying and cleaning of the vessel at the end of the process are facilitated. The movement of the vessel preferably transfers itself in such a way on the mix in the inside that results in a preferably irregular dispersion and aeration of the reaction mixture. Moreover, a directional movement occurs in preferred continuous processes according to the invention, so as to allow a continuous material transport. Suitable types of movement for the gravity mixers are particularly, rotation about a vessel axis (drum or rotary mixer), or about axes, which do not coincide with the geometrical axes of the vessel, or are perpendicular to its planes of symmetry (tumble mixer), or vibration, preferably at high amplitude and lower frequency, as well as changing directions of the amplitude such that shaking or tumbling movements occur.

In a particularly preferred embodiment of the process according to the invention, the solid moving carrier material in the rotating reactor forms a falling powder curtain, onto which is sprayed the first portion of the liquid binding agent, which is added in step i) of the inventive process.

In the context of the present invention, preferred rotating reactors are gravity mixers, particularly drum mixers, tumble mixers, cone mixers, double cone mixers or V-blenders.

The gravity mixers used according to the invention provide rotational or tumbling movements, which elevate the material inside and let it fall again, changing the angles of the walls and therefore changing direction, increasing or decreasing the space, displacing and separating the material flow. These types of mixers can have fixed inserts for improved aeration of the mix (e.g. flights), however preferred mixers have no mixing or cutting tooling as is the case for customary prior art high and low-speed mixers.

Inventive processes are particularly preferred, in which the gravity mixer is a double cone mixer with a rotatable vessel or mixing tools, wherein the double cone mixer is divided into a mixing zone and a post-mixing zone and has a deflection flight that is fixed to an end plate and from there extends through the whole mixing zone and optionally reaches into the post-mixing zone. Particularly preferred double cone mixers used according to the invention have the ratio of mixing zone length to post-mixing zone length of preferably at least 11.

The deflection flight can have a width from 50 to 150 mm, preferably from 75 to 130 mm. The upper edge of the deflection flight has a distance to the inner mixer wall amounting to preferably maximum 10% of the drum diameter at the narrowest point of the rotatable vessel, preferably maximum 5% of the narrowest point of the rotatable vessel and particularly less than 2.5% of the narrowest point of the rotatable vessel. In the post-mixing zone, the distance to the nearest inner mixer wall can always be larger than in the mixing zone; values between 100 and 300 mm are absolutely normal.

For continuous operation, those gravity mixers are particularly suitable that rotate about their horizontal, preferably their less inclined axis.

The inclination of the rotation axis causes the material mix, because of its own weight, to assume a directional movement that enables a continuous discharge of the mix out of the mixer. Such a directional movement can also be produced by a continuous feed of anionic surfactant and solid neutralizing agent, as well as by the inclined rotation axis. For the product properties, particularly for the adjustment of the bulk density and the solubility of the reaction product, it has proven advantageous if the angle of inclination of the rotation axis of a preferred rotating vessel correlates with a specific rotation speed. Accordingly, such inventive processes are particularly preferred in which the rotatable vessel of the gravity mixer has an angle of inclination a of 0 to 20°, particularly 0 to 15°, quite particularly preferably 1 to 15° and the movement of the rotatable vessel of the gravity mixer is simultaneously adjusted by the gears to 20 to 70 revolutions per minute and particularly to 30 to 60 revolutions per minute.

In preferred embodiments of the present inventive process, the residence time of the reaction mixture in the rotatable vessel is preferably less than 20 minutes, preferably between 1 and 600 seconds, particularly preferably between 1 and 300 seconds and especially between 1 and 120 seconds.

The velocity of the solid material in the rotating reactor preferably ranges between 0.2 and 20 m/sec, particularly preferably between 0.4 and 15 m/sec, quite particularly preferably between 0.8 and 7 m/sec and especially between 1.5 and 3 m/sec.

In the process according to the invention, the reaction mixture, after passing through the post-mixing zone, is transported into a fluidized bed. The transport can be made, for example, by a conveying device. If this conveying and feeding screw reaches into the post-mixing zone (it is also possible to have a direct connection between the conveying device and the discharge unit), then it is preferred that the screw protrudes only maximally into the second half of the post-mixing zone and therefore not into the part of the post-mixing zone, which includes the deflection flight.

The fluidized bed can be both a mechanical as well as a pneumatic fluidized bed. However, inventive processes, in which the fluidized bed in step ii) is a pneumatic fluidized bed, are preferred.

In the preferred pneumatic fluidized bed apparatus, the movement of the components of the mixture is produced by blowing in of air into the mix to be stirred. The fluidized bed can be operated continuously or discontinuously. The blown air preferably enters through holes provided in the porous floor. The bulk density of the partially granulated mixture on entering into the pneumatic fluidized bed is preferably between 300 and 700 g/l, particularly preferably between 350 and 650 g/l and especially between 400 and 600 g/l. Preferably, the air enters through the porous floor at least the fluidization velocity. The fluid bed is produced from the starting solid bed, the fluidized bed, which due to the free movement of the particles exhibits continuum properties similarly to a liquid. Preferably, the mix is almost cohesionless. An intensive mixing is first given—depending on the fineness of the mix—by 2 to 6 times the fluidization velocity; incoming gas velocities that are at least 2 times, preferably at least 4 times, particularly preferably at least 6 times and especially at least 8 times the value of the fluidization velocity, are therefore preferred in the context of the process according to the invention. The fluidization velocity w_{L} can be calculated with the help of the Ergun equation from the equilibrium of the forces between the weight F_{g} of the bulk and the pressure Fₚ—that with the surface area A multiplied by the pressure drop Δₚ over the layer through which flow occurs. Therefore:
W_{L}=42,9·(1−ε_{L})·v/dₚ·{(1+3,11·10⁻⁴[ε_{L}³/(1−ε_{L})²]·g·dₚ³·[ρₛ/ρ_{f}]/v²)^{0.5}−1}|
in which ε_{L} is the porosity of the layer before fluidization,
v is the kinematic viscosity of the air,
dₚ is the Sauter diameter d₃₂ of the particles in the layer
ρₛ, ρ_{f} are the density of the solid and the air, respectively

In preferred fluidized bed mixers, the floors are divided into sectors, which can be periodically aerated more or less strongly. This results in varying agitation in larger areas of the fluidized product. Further preferred are processes according to the invention in which the temperature of the aerating air is adjustable, wherein in particularly preferred variants of the process, the temperature differs from the exterior temperature, thus is either colder or warmer than the temperature of the surrounding air and/or in different areas of the fluidized bed, different temperatures for the incoming air are selected. Processes are particularly preferred, in which:
at the beginning of the fluidized bed, air is added with a temperature equal to or below the outside temperature, while the temperature of the incoming air over the course of the process rises to values above the outside temperature;
at the beginning of the fluidized bed, air is added with a temperature equal to or above the outside temperature, while the temperature of the incoming air over the course of the process sinks to values below the outside temperature;
at the beginning of the fluidized bed, air is added with a temperature equal to the outside temperature, while the temperature of the incoming air over the course of the process sinks to values below the outside temperature or rises to values above the outside temperature.

In preferred variants of the process, the temperature of the added cold air is less than 15° C., preferably less than 13° C. and particularly less than 10° C. The temperature of the hot air in preferred variants of the process has values above 28° C., preferably above 35° C., particularly preferably above 40° C. and especially above 50° C.

In process step ii) of the process according to the invention, a second portion of a liquid binding agent is sprayed by means of a spray device onto the fluidized bed formed in the fluidized bed reactor. In a preferred embodiment of the process according to the invention, the fluidized bed in step iii) has a depth between 2 and 100 cm, preferably between 4 and 80 cm, particularly preferably between 8 and 60 cm and especially between 10 and 40 cm.

The spraying can be made using high pressure spraying nozzles for a single material, spraying nozzles for two materials or spraying nozzles for three materials. For spraying with a single material spraying nozzle, the use of a high material pressure (5-15 MPa) is required, whereas spraying in spraying nozzles for two materials is carried out by means of compressed air (0.15-0.3 MPa). Spraying with spraying nozzles for two materials is particularly more favorable with regards to potential blockages, but is more expensive due to the high consumption of compressed air. The spraying nozzles for three materials, a modern development, has an additional air delivery system besides the compressed air flow for atomization and is intended to prevent the blockages and droplet formation at the nozzle. In the context of the process according to the invention, the use of spraying nozzles for two components, preferably those with a liquid feed-orifice between 2 and 6 mm, particularly between 3 and 5 mm is particularly preferred. The preferred distance of the spray device from the base plate of a preferred fluidized bed, used in step iii), is at least 30 cm, preferably at least 60 cm, particularly preferably at least 80 cm and especially at least 100 cm.

In a particularly preferred variant of the process according to the invention, the spraying head of the spraying device is placed above the surface of the fluid bed. Preferred processes are those in which the distance of the spray device from the surface of the fluidized bed in step iii) is at least 10 cm, preferably at least 30 cm and especially at least 50 cm. In particularly preferred embodiments of the process according to the invention, the distance of the spraying device from the surface of the fluid bed is between 15 and 140 cm, preferably between 20 and 130 cm, especially between 30 and 120 cm and especially between 40 and 110 cm. It has been demonstrated that the product properties, such as solubility or bulk density of the granules manufactured according to the invention can be advantageously influenced by the distance of the spraying device from the surface of the fluid bed.

The droplet diameter of the sprayed binding agent is preferably between 1 and 100 μm, particularly preferably between 2 and 80 μm, quite particularly preferably between 4 and 70 μm and especially between 8 and 60 μm. The temperature of the sprayed binding agent preferably ranges between 20 and 70° C., preferably between 25 and 60° C., particularly preferably between 30 and 55° C. and especially between 40 and 50° C.

The advantages of the process according to the invention can be particularly realized using such preferred process variants, in which the surface loading of the fluidized bed from the sprayed binding agent in step iii) of the process is between 0.0001 and 2.0 kg/(m²s), preferably between 0.001 and 2.0 kg/(m²s), particularly preferably between 0.002 and 2.0 kg/(m²s) and especially between 0.004 and 2.0 kg/(m²s). In preferred variants of the process according to the invention, the volume loading of the fluid bed from the sprayed binding agent in step iii) is between 0.0001 and 6.0 kg/m³s).

As described above, the liquid binding agent in the process according to the invention is brought to the solid carrier material in two portions. Accordingly, in the context of the present invention, such processes are particularly preferred, in which the first portion of the liquid binding agent in step i) comprises 55 to 90 wt. %, preferably between 65 and 90 wt. %, particularly preferably between 76 and 90 wt. % and especially between 80 and 90 wt. % of the total liquid binding agent used. By this preferred division of the binding agent addition, process products are obtained, which are characterized by an optimum solubility, as well as a low bulk density in the range of 300 to 700 g/l.

Preferred processes according to the invention are further characterized in that the bulk density of the granulated mixture on exiting the pneumatic fluidized bed is between 300 and 700 g/l, preferably between 400 and 700 g/l and especially between 500 and 650 g/l.

Liquid binding agents are reacted with solid carrier materials in the inventive dry neutralization process. Anionic surfactant acids are suitable liquid binding agents. In preferred embodiments of the process according to the invention, anionic surfactant acid(s) are used as liquid binding agents, particularly one or more substances from the group of carboxylic acids, half esters of sulfuric acid and sulfonic acids, preferably from the group of fatty acids, the fatty alkyl sulfuric acids and the alkylaryl sulfonic acids, particularly from the group of C₈₋₁₆—, particularly the C₉₋₁₃-alkylbenzene sulfonic acids. These will be described below.

In order to possess adequate surface-active properties, the cited compounds should consequently incorporate longer chain hydrocarbon radicals, i.e. there should be at least 6 carbon atoms in the alkyl or alkenyl radicals. Normally, the carbon chain distributions of the anionic surfactants are between 6 and 40, preferably 8 and 30 and especially between 12 and 22 carbon atoms.

Carboxylic acids, which find use in the form of their alkali metal salts in laundry and cleaning products, are for the most part obtained industrially from natural fats and oils by hydrolysis. While the alkaline saponification process, already used in the previous century, afforded the alkali salts (soaps), today, industrially, only water is used to cleave the fats into glycerin and free fatty acids. Industrially practiced processes are e.g. cleavage in autoclaves or continuous high-pressure cleavage. In the context of the present invention, suitable carboxylic acids as the acid form of anionic surfactants are, for example, hexanoic acid (capronic acid), heptanoic acid (enanthic acid), octanoic acid (caprylic acid), nonanoic acid (pelargonic acid), decanoic acid (caprinic acid), undecanoic acid etc. In the context of the present invention, preferred suitable fatty acids are dodecanoic acid (laurinic acid), tetradecanoic acid (myristinic acid), hexadecanoic acid (palmitinic acid), octadecanoic acid (stearinic acid), eicosanoic acid (arachinic acid), docosanoic acid (behenic acid), tetracosanoic acid (lignocerinic acid), hexacosanoic acid (cerotinic acid), triacotanoic acid (melissinic acid) as well as the unsaturated series 9c-hexadecenoic acid (palmitoleinic acid), 6c-octadecenoic acid (petroselinic acid), 6t-octadecenoic acid (petroselaidinic acid), 9c-octadecenoic acid (olic acid), 9t-octadecenoic acid (elaidinic acid), 9c,12c-octadecadienoic acid (linolic acid), 9t, 12t-octadecadienoic acid (linolaidinic acid) und 9c, 12c, 15c-octadecatrienoic acid (linolenic acid). For reasons of cost, it is preferred not to use the pure species but rather technical mixtures of the individual acids, just as they are obtained by fat cleavage. Such mixtures are, for example cocoa oil fatty acid (ca. 6 wt. % C₈, 6 wt. % C₁₀, 48 wt. % C₁₂, 18 wt. % C₁₄, 10 wt. % C₁₆, 2 wt % C₁₈, 8 wt. % C_{18′}, 1 wt. % C_{18″}), palm nut oil fatty acid (ca. 4 wt. % C₈, 5 wt. % C₁₀, 50 wt. % C₁₂, 15 wt. % C₁₄, 7 wt. % C₁₆, 2 wt. % C₁₈, 15 wt. % C_{18′}, 1 wt. % C_{18″}), tallow fatty acid (ca. 3 wt. % C₁₄, 26 wt. % C₁₆, 2 wt. % C_{16′}, 2 wt. % C₁₇, 17 wt. % C₁₈, 44 wt. % C_{18′}, 3 wt. % C_{18″}, 1 wt. % C_{18′″}), hydrogenated tallow fatty acid (ca. 2 wt. % C₁₄, 28 wt. % C₁₆, 2 wt. % C₁₇, 63 wt. % C₁₈, 1 wt. % C_{18′}), technical oleic acid (ca. 1 wt. % C₁₂, 3 wt. % C₁₄, 5 wt. % C₁₆, 6 wt. % C_{16′}, 1 wt. % C₁₇, 2 wt. % C₁₈, 70 wt. % C_{18′}, 10 wt. % C_{18″}, 0,5 wt. % C_{18′″}), technical palmitic/stearic acid (ca. 1 wt. % C12, 2 wt. % C14, 45 wt. % C16, 2 wt. % C17, 47 wt. % C18, 1 wt. % C_{18′}) as well as soya bean oil fatty acid (ca. 2 wt. % C₁₄, 15 wt. % C₁₆, 5 wt. % C₁₈, 25 wt. % C_{18′}, 45 wt. % C_{18″}, 7 wt. % C_{18′″}).

Sulfuric acid half esters of longer chain alcohols are also anionic surfactants in their acid form and are suitable in the context of the inventive process. Their alkali metal salts, particularly sodium salts, the fatty alcohol sulfates are obtained industrially from fatty alcohols, which are reacted with sulfuric acid, chlorosulfonic acid, amidosulfonic acid or sulfur trioxide to afford the corresponding alkylsulfur acids and subsequently neutralized. The fatty alcohols are thus obtained from the corresponding fatty acids or fatty acid mixtures by high pressure hydrogenation of the fatty acid methyl esters. The quantitatively most important industrial process for the manufacture of fatty alkyl sulfuric acids is the sulfonation of the alcohols with SO₃/air mixtures in special cascade, falling film or multi-tube reactors.

A further class of anionic surfactant acids, which can be used in the process according to the invention, are the alkyl ether sulfuric acids, their salts, the alkyl ether sulfates, which in comparison to the alkyl sulfates possess a higher water solubility and are less sensitive towards hard water (solubility of the Ca salts). Alkyl ether sulfuric acids are synthesized, like the alkyl sulfuric acids, from fatty alcohols, which are reacted with ethylene oxide to afford the corresponding fatty alcohol ethoxylates. Propylene oxide can also be used instead of ethylene oxide. The subsequent sulfonation with gaseous sulfur trioxide in short-time sulfonation reactors affords yields of over 98% of the corresponding alkyl ether sulfuric acids.

Alkanesulfonic acids and olefinsulfonic acids are also suitable anionic surfactants in the context of the present invention. Alkanesulfonic acids can contain a terminal sulfonic acid group (primary alkanesulfonic acids) or one along the carbon chain (secondary alkanesulfonic acids), wherein only the secondary alkanesulfonic acids have commercial importance. They are manufactured by sulfochlorination or sulfoxidation of linear hydrocarbons. For sulfochlorination according to Reed, n-paraffins are converted with sulfur trioxide and chlorine under UV-irradiation to the corresponding sulfochlorides, which directly afford the alkanesulfonates on hydrolysis with alkalies and alkanesulfonic acids on hydrolysis with water. As the by-products from the radical reactions—di- and polysulfochlorides, as well as chlorinated hydrocarbons—can result from the sulfochlorination, the reaction is normally carried out with conversions of 30% and then terminated.

Another manufacturing process for alkanesulfonic acids is sulfoxidation, where n-paraffins are reacted with sulfur trioxide and oxygen under UV-irradiation. This radical reaction affords successive alkylsulfonyl radicals, which further react with oxygen to yield alkylpersulfonyl radicals. The reaction with unreacted paraffin affords an alkyl radical and the alkylpersulfonic acid, which decomposes into an alkylperoxysulfonyl radical and a hydroxyl radical. The reaction of both the radicals with unreacted paraffin affords the alkylsulfonic acids and water, which reacts with alkylpersulfonic acid and sulfur trioxide to sulfuric acid. In order to maintain the highest possible yield of both the end products, alkylsulfonic acid and sulfuric acid, and to suppress side reactions, this reaction is normally run with conversion rates of up to 1% and then interrupted.

Olefinsulfonates are manufactured industrially by the reaction of α-olefins with sulfur trioxide. They form zwitterions, which cyclize to so-called sultones. Under suitable conditions (alkaline or acid hydrolysis), these sultones react to form hydroxyalkanesulfonic acids or alkenesulfonic acids, both of which can also be used as anionic surfactant acids.

Alkylbenzenesulfonates have been known since the thirties of this century as powerful anionic surfactants. At that time, alkylbenzenes were manufactured by monochlorinating Kogasin fractions and subsequent Friedel-Crafts alkylation, and were sulfonated with oleum and neutralized with sodium hydroxide. For the manufacture of alkylbenzenesulfonates at the beginning of the fifties, propylene was tetramerized to branched α-dodecene and the product was converted with aluminum trichloride or hydrogen fluoride, using a Friedel-Crafts reaction, to tetrapropylbenzene that was subsequently sulfonated and neutralized. This economic possibility for manufacturing tetrapropylbenzenesulfonic acid (TPS) led to a breakthrough of this class of surfactant, which subsequently displaced the soaps as the major surfactant in laundry and cleaning products.

The inadequate biodegradability of TPS necessitated the synthesis of new alkylbenzenesulfonates, which possess an improved ecological behaviour. These requirements were fulfilled by linear alkylbenzenesulfonates, which are almost the sole alkylbenzenesulfonates manufactured today and are abbreviated to ABS.

Linear alkylbenzenesulfonates are manufactured from alkylbenzenes, which are again obtained from linear olefins. For this, commercial petroleum fractions are separated into the n-paraffins using molecular sieves, and dehydrogenated to the n-olefins, resulting in both α- as well as i-olefins. The resulting olefins, in the presence of acid catalysts and benzene, are then converted into the alkylbenzenes, wherein the choice of Friedel-Crafts catalyst has an influence on the isomer distribution of the resulting linear alkylbenzenes. By using aluminum trichloride, the content of the 2-phenyl isomers in the mixture with the 3-, 4-, 5- and other isomers, is ca. 30 wt. %; in contrast, when hydrogen fluoride is used as the catalyst, the content of 2-phenyl isomer sinks below ca. 20 wt. %. Finally, today's commercial sulfonation of linear alkylbenzenes is with oleum, sulfuric acid or gaseous sulfur trioxide, the last being by far the most important. Special film or multi-tube reactors are used for sulfonation, yielding a 97% pure alkylbenzenesulfonic acid product (ABSS), which can be used as the anionic surfactant acid in the context of the present invention.

The most varied salts, i.e. alkylbenzene sulfonates, can be obtained from the ABSS by choosing the neutralizing agent. On economic grounds, it is preferred here to manufacture and use the alkali metal salts and among them, preferably the sodium salts of the ABSS. These can be described by means of the general Formula I: 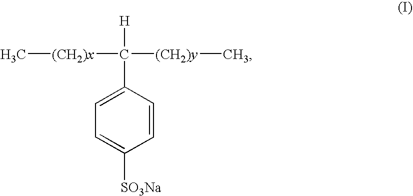
in which the sum of x and y lies normally between 5 and 13. Inventive processes, in which C₈₋₁₆, preferably C₉₋₁₃-alkylbenzenesulfonic acids are added as the anionic surfactants in acid form, are preferred. It is further preferred in the context of the present invention to use C₈₋₁₆, preferably C₉₋₁₃-alkylbenzenesulfonic acids, which derive from alkylbenzenes that have a tetralin content below 5 wt. %, based on the alkylbenzene. It is additionally preferred to use alkylbenzenesulfonic acids, whose alkylbenzenes were manufactured by the HF-process, such that the added C₈₋₁₆, preferably C₉₋₁₃-alkylbenzenesulfonic acids have a content of 2-phenyl isomer below 22 wt. %, based on the alkylbenzenesulfonic acid.

The abovementioned anionic surfactants can be used in their acid form, alone or in mixtures with each other, in the process according to the invention. However, it is also possible and preferred that additional, preferably acid ingredients of laundry and cleaning products be mixed in quantities of 0.1 to 40 wt. %, preferably from 1 to 15 wt. % and especially from 2 to 10 wt. %, each based on the weight of the anionic surfactant acid-containing mixture, with the anionic surfactant in acid form before the addition to the solid neutralizing agent.

Beside the “surfactant acids”, the cited fatty acids, phosphonic acids, polymer acids or partially neutralized polymer acids as well as “builder acids” and “complex builder acids”, individually as well as in any mixtures, are also suitable liquid binding agents in the context of the present invention. Suitable detergent ingredients, which may be added to the anionic surfactant acid before foaming, are above all, acidic detergent ingredients, i.e. for example phosphonic acids, which in neutralized form (phosphonates), are present as incrustation inhibitors in many detergents. According to the invention, (partly neutralized) polymer acids, such as polyacrylic acids for example, may also be used. However, acid-stable ingredients may also be mixed with the anionic surfactant acid. Suitable ingredients of this type are, for example, so-called minor components which would otherwise have to be added in expensive additional steps, i.e. for example optical brighteners, dyes etc., the acid stability having to be tested in each individual case.

Preferably, nonionic surfactants are mixed with the anionic surfactants in acid form in quantities from 0.1 to 40 wt. %, preferably from 1 to 15 wt. % and especially from 2 to 10 wt. %, each based on the weight of the anionic surfactant acid-containing mixture. This addition can improve the physical properties of the anionic surfactant acid foam and can eliminate the need for nonionic surfactants to be subsequently incorporated in the surfactant granules or in the detergent as a whole. The various representatives from the group of nonionic surfactants are described further below.

Independently of whether an individual anionic surfactant acid or a plurality of anionic surfactant acids—optionally in mixtures with additional acids or acid-stable ingredients—is/are added to the solid carrier material or the mixture of a plurality of solids, it is preferred that the temperature of the added mixture be as low as possible. Here, processes according to the invention are preferred, in which the liquid binding agent, on entering the gravity mixer has a temperature between 20 and 70° C., preferably between 25 and 60° C., particularly preferably between 30 and 55° C. and especially between 40 and 50° C.

By respecting these temperature specifications, it is especially possible in a preferred process variant with a given ratio of anionic surfactant acid to sodium carbonate, to control the content of sodium hydrogen carbonate in the process product. The anionic surfactant acid, which optionally contains additional acid components, is described therein as the “liquid, acid component”.

On running the process according to the invention, the preferred reaction between anionic surfactant acid(s) and sodium carbonate is controlled in such a way that the reaction
Na₂CO₃+2 anionic surfactant-H→2 anionic surfactant-Na+CO₂+H₂O
is largely inhibited and in its place the reaction
Na₂CO₃+anionic surfactant-H→anionic surfactant-Na+NaHCO₃
occurs. For this, the sodium carbonate is added in excess, such that the unreacted sodium carbonate remains in the product, while additional sodium hydrogen carbonate forms in the reaction. According to the invention, the ratio of the amount of sodium carbonate in the composition (based on the composition, neglecting any possible content of water of hydration), to the amount of sodium hydrogen carbonate in the composition (based on the composition, neglecting any possible content of water of hydration) must be equal to or greater than 5:1. In other words, according to the invention, the process product comprises at least 5 grams Na₂CO₃ for every gram of NaHCO₃.

In preferred embodiments of the present invention, the weight ratio of sodium carbonate to sodium hydrogen carbonate lies within narrow limits, wherein for preferred processes according to the invention, the weight ratio of sodium carbonate to sodium hydrogen carbonate in the end product of the process ranges from 50:1 to 2:1, preferably 40:1 to 2.1:1, particularly preferably 35:1 to 2.2:1 and especially 30:1 to 2.25:1.

The content of sodium hydrogen carbonate in the preferred composition according to the invention can vary in relation to the added quantities of sodium carbonate and anionic surfactant acid(s). In preferred processes according to the invention, the content of sodium hydrogen carbonate in the end products of the process ranges from 0.01 to 20 wt. %, preferably 0.1 to 15 wt. %, particularly preferably 0.5 to 10 wt. % and especially 1 to 10 wt. %, each based on the total weight of the end products of the process.

The neutralized form of the anionic surfactant acids, abbreviated to anionic surfactants, can also be comprised in varying amounts in the compositions manufactured according to the inventive process. All acids known from the prior art can be used here as anionic surfactant acids. They were described in detail above. Preferred processes according to the invention are characterized in that the content of neutralized anionic surfactant acids in the end products of the process is maximum 50 wt. %, preferably 8 to 42 wt. %, particularly preferably 10 to 35 wt. % and especially 15 to 25 wt. %.

The compositions manufactured according to the inventive process can have different bulk densities, which vary according to the content of the individual ingredients and other process parameters. Processes according to the invention are preferred, in which the bulk density of the end products of the process are 300 to 800 g/l, preferably 330 to 650 g/l, particularly preferably 350 to 550 g/l and especially 400 to 500 g/l.

The products of the process according to the invention additionally have a particle size distribution with a median particle size d₅₀ below 5000 μm, preferably between 20 and 3000 μm, particularly preferably between 40 and 2000 μm and especially between 50 and 1600 μm.

The end products of the process according to the invention are preferably low in humidity and are preferably characterized by their water content, determined by loss on drying at 120° C., of less than 15 wt. %, preferably less than 10 wt. %, particularly preferably less than 5 wt. % and especially less than 2.5 wt. %, each based on the total weight of the end products of the process after having left the fluidized bed.

The water content of the end products of the process, determined by loss on drying at 120° C., are <15 wt. %, preferably <10 wt. %, particularly preferably <5 wt. % and especially <2.5 wt. % In general, the low humidity process conditions are preferred in order to guarantee the desired reaction to sodium hydrogen carbonate. Therefore, the added raw materials should be added as dry as possible, dried or low in water. According to the invention, highest possible concentrations of the anionic surfactant acids are preferably chosen, as long as the technical control of the process (agitation of the anionic surfactant acid and addition to the sodium carbonate) is properly guaranteed.

A further possibility for promoting the formation of sodium hydrogen carbonate and for avoiding the formation of carbon dioxide and water consists in maintaining the lowest possible temperatures. This can be achieved for example, by cooling, but also by means of a suitable process control or by adjusting the amounts of reactants. Here, processes according to the invention are preferred, in which the temperature during the process is held below 100° C., preferably below 80° C., particularly preferably below 60° C. and especially below 50° C.

The process according to the invention is based on the reaction or granulation of liquid binding agents with solid carrier materials. In the preferred case, only anionic surfactant acid and sodium carbonate are brought to react with each other. However, the reaction mixture can also comprise additional materials that can either participate in the reaction or not. These reactive or inert materials can be added, prior to the reaction, either to the sodium carbonate or to the anionic surfactant acid(s); alternatively, both reactants can also comprise further reactive or inert ingredients.

In the context of the present invention, it is preferred to mix additional ingredients with the sodium carbonate, especially additional, preferably solid carrier materials. This mixture forms the solid bed, onto which the anionic surfactant acid(s)—optionally mixed with additional substances—is/are added. In this manner, additional neutralizing agents, for example, can be mixed in the sodium carbonate, solid neutralizing agents being preferred. Aqueous solutions of neutralizing agents (particularly alkalies) can be similarly added to the sodium carbonate, as long as the total water balance of the process (the water content of the end products of the process) is not loaded over and above the cited limits. Therefore, the addition of low water-content raw materials or even anhydrous raw materials is preferred. Processes according to the invention are particularly preferred, in which the solid carrier materials further contain one or more materials from the group sodium hydroxide, sodium sesquicarbonate, potassium hydroxide and/or potassium carbonate.

As an alternative or in addition to the addition of further solid carrier materials, carrier materials that do not participate in the reaction can be added to the sodium carbonate. They should then have adequate stability towards the added acids, so as to avoid local decomposition and resulting undesirable discoloration or other problems with the product. Here, processes are preferred, in which the solid bed comprises additional solids from the groups of the silicates, aluminum silicates, sulfates, citrates and/or phosphates. It is particularly preferred that sodium sulfate, which is comprised up to 45 wt. % in detergents still today in some countries, is mixed with the solid neutralizing agent(s). A detailed description of these preferred solid carrier materials can be found further below in the text. For this embodiment, reference is made to that text, in order to avoid repetitions.

Further materials can be mixed in with the reaction mixture during and/or after the fluidization in step iii) of the process according to the invention. In the context of the present invention, it is preferred to add partitioning agents or surface modifiers.

All known finely dispersed representatives of this group can be used as partitioning agents or surface modifiers. Amorphous and/or crystalline aluminosilicates, such as zeolith A, X and/or P, various types of silica, calcium stearate, carbonates, sulfates and also finely dispersed compounds, for example from amorphous silicates and carbonates are preferred here.

Processes according to the invention wherein the granulation mixture is subjected to a post treatment after exiting the pneumatic fluidized bed are preferred.

The liquid binding agents added in the process steps i) and/or iii) can also contain additional constituents beside the abovementioned, preferred added anionic surfactants. These preferred additional binding agents include aqueous polymer solutions or dispersions, as well as aqueous solutions of water glass. Preferred aqueous polymer solutions are particularly aqueous solutions or dispersions of homopolymers or copolymers of acrylic acid, particularly of polyacrylates and/or copolymers of acrylic acid with methacrylic acid and/or copolymers of acrylic acid with maleic acid. More exact descriptions of the preferred added polyacrylates, like the copolymeric polycarboxylates are found in the text further below.

The surfactant granules manufactured according to the inventive process are particularly suitable for the manufacture of laundry or cleaning products, particularly solid laundry or cleaning products, for example by additional agglomeration, by extrusion or compaction. Besides the components already mentioned, such as the anionic surfactant acids, typical laundry and cleaning products comprise further ingredients, particularly from the group of builders, co-builders, bleaching agents, bleach activators, dyestuffs and fragrances, optical brighteners, enzymes, soil-release polymers etc. For the sake of completeness, these materials are described below.

Builders are added to laundry or cleaning products principally to bind calcium and magnesium. In the context of the invention, typical builders, the low molecular polycarboxylic acids and their salts, the homopolymeric and copolymeric polycarboxylic acids and their salts, the carbonates, phosphates and sodium and potassium silicates, are preferably present in quantities from 22.5 to 45 wt. %, preferably from 25 to 40 wt. % and especially from 27,5 to 35 wt. %, each based on the total composition, which also comprises the end products of the process according to the invention. Trisodium citrate and/or pentasodium tripolyphosphate and silicate builders from the class of alkali disilicates are preferred for laundry and cleaning agents. Generally, the potassium and sodium salts are preferred among the alkaline metal salts, as they often have a higher solubility in water. Preferred water-soluble builders are tripotassium citrate, potassium carbonate and potash water glasses, for example.

Laundry and cleaning products can comprise phosphates as builders, preferably alkaline metal phosphates with particular preference for pentasodium or pentapotassium triphosphate (sodium or potassium tripolyphosphate).

Alkali metal phosphates is the collective term for the alkali metal (more particularly sodium and potassium) salts of the various phosphoric acids, including metaphosphoric acids (HPO₃)ₙ and orthophosphoric acid (H₃PO₄) and representatives of higher molecular weight. The phosphates combine several advantages: they act as alkalinity sources, prevent lime deposits and, in addition, contribute towards the cleaning effect.

The laundry and cleaning products can comprise condensed phosphates as water softeners with particular preference. These materials form a group of phosphates—known as fused or calcined phosphates from their manufacturing process—that derive from acidic salts of orthophosphoric acid (phosphorus acids) by condensation. The condensed phosphates can be classified into metaphosphates [M′(PO₃)ₙ] and polyphosphates (M′ₙ₊₂PₙO₃ₙ₊₁ or M′ₙH₂PₙO₃ₙ₊₁).

The term “metaphosphate” was originally the general designation for condensed phosphates with the composition Mₙ[PₙO₃ₙ] (M=monovalent metal), but nowadays is mostly limited to salts of cyclic cyclo(poly)phosphate anions.

For n=3, 4, 5, 6 etc., one uses tri-, tetra-, penta-, hexa-metaphosphates, etc. According to the systematic nomenclature of the isopolyanions, the anion, for example with n=3 is described as the cyclotriphosphate.

Metaphosphates are obtained as impurities of Graham's salts—wrongly designated as sodium hexametaphosphate—by heating NaH₂PO₄ to temperatures above 620° C., forming intermediates of Maddrell's salt. These and Kurrol's salt are linear polyphosphates, which are mostly not considered as metaphosphates nowadays, but which, in the context of the present invention are also advantageously added as water softeners.

The crystalline, water-insoluble Maddrell's salt (NaPO₃)ₓ with x>1000, which can be obtained at 200-300° C. from NaH₂PO₄, is converted at ca. 600° C. into the cyclic metaphosphate [Na₃(PO₃)₃], which melts at 620° C. Depending on the reaction conditions, the quenched, glassy melt is either the water-insoluble Graham's salt, (NaPO₃)₄₀₋₅₀, or a glassy, condensed phosphate with the composition (NaP0₃)₁₅₋₂₀, which is known as Calgon. The misleading term hexametaphosphate is still in use for both products. The so-called Kurrol's salt, (NaPO₃)ₙ with n>>5000, also results from the 600° C. fusion of Maddrell's salt, if this is left at 500° C. for a short period. It forms high polymeric, water-insoluble fibers.

From the previously cited classes of condensed phosphates, the “hexametaphosphates” Budit® H6 and H8 from the company Budenheim have proved to be particularly preferred water softeners.

Suitable silicate builders are the crystalline, layered sodium silicates corresponding to the general formula NaMSiₓO₂ₓ₊₁.H₂O, wherein M is sodium or hydrogen, x is a number from 1.9 to 4 and y is a number from 0 to 20, preferred values for x being 2, 3 or 4. Preferred crystalline layered silicates of the given formula are those in which M stands for sodium and x assumes the values 2 or 3. Both β- and δ-sodium disilicates Na₂Si₂O₅.yH₂O are preferred.

Other useful builders are amorphous sodium silicates with a modulus (Na₂O:SiO₂ ratio) of 1:2 to 1:3.3, preferably 1:2 to 1:2.8 and more preferably 1:2 to 1:2.6 and which dissolve with a delay and exhibit multiple wash cycle properties. The delay in dissolution compared with conventional amorphous sodium silicates can have been obtained in various ways, for example by surface treatment, compounding, compressing/compacting or by over-drying. In the context of the invention, the term “amorphous” is also understood to encompass “X-ray amorphous”. In other words, the silicates do not produce any of the sharp X-ray reflections typical of crystalline substances in X-ray diffraction experiments, but at best one or more maxima of the scattered X-radiation, which have a width of several degrees of the diffraction angle. However, particularly good builder properties may even be achieved where the silicate particles produce indistinct or even sharp diffraction maxima in electron diffraction experiments. This can be interpreted to mean that the products have microcrystalline regions between 10 and a few hundred nm in size, values of up to at most 50 nm and especially up to at most 20 nm being preferred. These types of X-ray amorphous silicates similarly possess a delayed dissolution in comparison with the customary water glasses. Compacted/densified amorphous silicates, compounded amorphous silicates and overdried X-ray-amorphous silicates are particularly preferred.

Of the suitable fine crystalline, synthetic zeolites containing bound water, zeolite A and/or PA are preferred. A particularly preferred zeolite P is zeolite MAP® (a commercial product of Crosfield). However, the zeolites X, as well as mixtures of A, X and/or P, are also suitable. Commercially available and preferred in the context of the present invention is, for example, also a co-crystallizate of zeolite X and zeolite A (ca. 80 wt. % zeolite X), which is marketed under the name of VEGOBOND AX® by Condea Augusta S.p.A. and which can be described by the Formula
nNa₂O.(1-n)K₂O.Al₂O₃.(2-2.5)SiO₂.(3.5-5.5)H₂O

Suitable zeolites have a mean particle size of less than 10 μm (volume distribution, as measured by the Coulter Counter Method) and contain preferably 18 to 22% by weight and more preferably 20 to 22% by weight of bound water.

As well as the builders, further preferred ingredients of laundry or cleaning products are particularly acidifying agents, chelate complexing agents or deposit-inhibiting polymers.

Possible acidifiers are either inorganic acids or organic acids, provided these are compatible with the other ingredients. For reasons of consumer protection and handling safety, the solid mono-, oligo- and polycarboxylic acids in particular can be used. From this group, preference is in turn given to citric acid, tartaric acid, succinic acid, malonic acid, adipic acid, maleic acid, fumaric acid, oxalic acid, and polyacrylic acid. The anhydrides of these acids can also be used as acidifiers, maleic anhydride and succinic anhydride in particular being commercially available. Organic sulfonic acids, such as amidosulfonic acid can likewise be used. A product which is commercially available and which can likewise preferably be used as acidifier for the purposes of the present invention is Sokalan(R) DCS (trade mark of BASF), a mixture of succinic acid (max. 31% by weight), glutaric acid (max. 50% by weight) and adipic acid (max. 33% by weight).

A further possible group of ingredients is the chelate complexing agents. Chelate complexing agents are substances which form cyclic compounds with metal ions, where a single ligand occupies more than one coordination site on a central atom, i.e. is at least “bidentate”. In this case, linear compounds are thus normally closed by complex formation via an ion to give rings. The number of bonded ligands depends on the coordination number of the central ion.

Chelate complexing agents, which are customary and preferred for the purposes of the present invention are, for example, polyoxycarboxylic acids, polyamines, ethylenediaminetetraacetic acid (EDTA) and nitrilotriacetic acid (NTA). Complex-forming polymers, i.e. polymers which carry functional groups either in the main chain itself or in side chains, which can act as ligands and react with suitable metal atoms usually to form chelate complexes, can also be used according to the invention. The polymer-bonded ligands of the resulting metal complexes can originate from just one macromolecule or else belong to different polymer chains. The latter leads to crosslinking of the material, provided the complex-forming polymers have not already been crosslinked beforehand through covalent bonds.

Complexing groups (ligands) of customary complex-forming polymers are iminodiacetic acid, hydroxyquinoline, thiourea, guanidine, dithiocarbamate, hydroxamic acid, amidoxime, aminophosphoric acid, (cycl.) polyamino, mercapto, 1,3-dicarbonyl and crown ether radicals, some of which having very specific activities toward ions of different metals. Basis polymers of many complex-forming polymers, which are also commercially important, are polystyrene, polyacrylates, polyacrylonitriles, polyvinyl alcohols, polyvinyl pyridines and polyethylene imines. Naturally occurring polymers, such as cellulose, starch or chitin are also complex-forming polymers. Moreover, these may be provided with further ligand functionalities as a result of polymer-analogous modifications.

For the purposes of the present invention, particular preference is given to laundry or cleaning products, which comprise one or more chelate complexing agents from the groups of
polycarboxylic acids in which the sum of the carboxyl and optionally hydroxyl
groups is at least 5,
nitrogen-containing mono- or polycarboxylic acids,
geminal diphosphonic acids,
aminophosphonic acids,
phosphonopolycarboxylic acids,
cyclodextrins
   in amounts above 0.1% by weight, preferably above 0.5% by weight, particularly preferably above 1% by weight and in particular above 2.5% by weight, in each case based on the weight of the dishwasher product.

For the purposes of the present invention, it is possible to use all complexing agents of the prior art. These may belong to various chemical groups. Preference is given to using the following, individually or in a mixture with one another:
polycarboxylic acids in which the sum of the carboxyl and optionally hydroxyl groups is at least 5, such as gluconic acid,
nitrogen-containing mono- or polycarboxylic acids, such as ethylenediaminetetraacetic acid (EDTA), N-hydroxyethylethylenediaminetriacetic acid, diethylenetriaminepentaacetic acid, hydroxyethyliminodiacetic acid, nitrilotriacetic acid-3-propionic acid, isoserinediacetic acid, N,N-di(β-hydroxyethyl)glycine, N-(1,2-dicarboxy-2-hydroxyethyl)glycine, N-(1,2-dicarboxy-2-hydroxyethyl)aspartic acid or nitrilotriacetic acid (NTA),
geminal diphosphonic acids, such as 1-hydroxyethane1,1-diphosphonic acid (HEDP), higher homologs thereof having up to 8 carbon atoms, and hydroxy or amino group-containing derivatives thereof and 1-aminoethane-1,1-diphosphonic acid, higher homologs thereof having up to 8 carbon atoms, and hydroxy or amino group-containing derivatives thereof,
aminophosphonic acids, such as ethylenediaminetetra(methylenephosphonic acid), diethylenetriaminepenta(methylenephosphonic acid) or nitrilotri(methylenephosphonic acid),
phosphonopolycarboxylic acids, such as 2-phosphonobutane-1,2,4-tricarboxylic acid, and
cyclodextrins.

For the purposes of this patent application, polycarboxylic acids a) are understood as meaning carboxylic acids—including monocarboxylic acids—in which the sum of carboxyl and the hydroxyl groups present in the molecule is at least 5. Complexing agents from the group of nitrogen-containing polycarboxylic acids, in particular EDTA, are preferred. At the alkaline pH values of the treatment solutions required according to the invention, these complexing agents are at least partially in the form of anions. It is unimportant whether they are introduced in the form of acids or in the form of salts. In the case of using salts, alkali metal, ammonium or alkylammonium salts, in particular sodium salts, are preferred.

Deposit-inhibiting polymers may likewise be present in the products according to the invention. These substances, which may have chemically different structures, originate, for example, from the groups of low molecular weight polyacrylates with molar masses between 1000 and 20 000 daltons, preference being given to polymers with molar masses below 15 000 daltons.

Deposit-inhibiting polymers may also have cobuilder properties. Organic cobuilders which may be used in the compositions, which comprise the end products of the process according to the invention are, in particular, polycarboxylates/polycarboxylic acids, polymeric polycarboxylates, aspartic acid, polyacetals, dextrins, further organic cobuilders (see below) and phosphonates. These classes of substance are described below.

Organic builder substances which can be used are, for example, the polycarboxylic acids usable in the form of their sodium salts, the term polycarboxylic acids meaning carboxylic acids which carry more than one acid function. Examples of these are citric acid, adipic acid, succinic acid, glutaric acid, malic acid, tartaric acid, maleic acid, fumaric acid, sugar acids, aminocarboxylic acids, nitrilotriacetic acid (NTA), provided such a use is not objectionable on ecological grounds, and mixtures thereof. Preferred salts are the salts of the polycarboxylic acids such as citric acid, adipic acid, succinic acid, glutaric acid, tartaric acid, sugar acids and mixtures thereof.

The acids per se may also be used. In addition to their builder action, the acids typically also have the property of an acidifying component and thus also serve to establish a lower and milder pH of laundry or cleaning products. In this connection, particular mention is made of citric acid, succinic acid, glutaric acid, adipic acid, gluconic acid and any mixtures thereof.

Also suitable as builders or deposit inhibitors are polymeric polycarboxylates; these are, for example, the alkali metal salts of polyacrylic acid or of polymethacrylic acid, for example those having a relative molecular mass of from 500 to 70 000 g/mol.

The molecular weights given for polymeric polycarboxylates are, for the purposes of this specification, weight-average molecular weights M_{w} of the respective acid form, determined fundamentally by means of gel permeation chromatography (GPC) using a UV detector. The measurement was made against an external polyacrylic acid standard, which, owing to its structural similarity to the polymers under investigation, provides realistic molecular weight values. These figures differ considerably from the molecular weight values obtained using polystyrenesulfonic acids as the standard. The molecular weights measured against polystyrenesulfonic acids are usually considerably higher than the molecular weights given in this specification.

Suitable polymers are, in particular, polyacrylates which preferably have a molecular weight of from 2000 to 20 000 g/mol. Owing to their superior solubility, preference in this group may be given in turn to the short-chain polyacrylates which have molecular weights of from 2000 to 10 000 g/mol and particularly preferably from 3000 to 5000 g/mol.

Also suitable are copolymeric polycarboxylates, in particular those of acrylic acid with methacrylic acid and of acrylic acid or methacrylic acid with maleic acid. Copolymers, which have proven to be particularly suitable, are those of acrylic acid with maleic acid, which contain from 50 to 90% by weight of acrylic acid and 50 to 10% by weight of maleic acid. Their relative molecular weights, based on free acids, is generally 2000 to 70 000 g/mol, preferably 20 000 to 50 000 g/mol and in particular 30 000 to 40 000 g/mol.

The (co)polymeric polycarboxylates can be used either as powders or as aqueous solutions. The (co)polymeric polycarboxylate content of the agents is preferably 0.5 to 20% by weight, in particular 3 to 10% by weight.

Particular preference is also given to biodegradable polymers of more than two different monomer units, for example those which contain, as monomers, salts of acrylic acid or of maleic acid, and vinyl alcohol or vinyl alcohol derivatives, or those which contain, as monomers, salts of acrylic acid and of 2-alkylallylsulfonic acid, and sugar derivatives. Further preferred copolymers are those, which preferably have, as monomers, acrolein and acrylic acid/acrylic acid salts or acrolein and vinyl acetate.

Further preferred builder substances, which are also to be mentioned, are polymeric aminodicarboxylic acids, salts thereof or precursor substances thereof. Particular preference is given to polyaspartic acids or salts and derivatives thereof, which also have a bleach-stabilizing effect as well as cobuilder properties.

Further suitable builder substances are polyacetals, which can be obtained by reacting dialdehydes with polyolcarboxylic acids, which have 5 to 7 carbon atoms and at least 3 hydroxyl groups. Preferred polyacetals are obtained from dialdehydes, such as glyoxal, glutaraldehyde, terephthalaldehyde, and mixtures thereof and from polyolcarboxylic acids, such as gluconic acid and/or glucoheptonic acid.

Further suitable organic builder substances are dextrins, for example oligomers or polymers of carbohydrates, which can be obtained by partial hydrolysis of starches. The hydrolysis can be carried out in accordance with customary processes, for example acid-catalyzed or enzyme-catalyzed processes. The hydrolysis products preferably have average molecular weights in the range from 400 to 500 000 g/mol. Preference is given here to a polysaccharide with a dextrose equivalent (DE) in the range from 0.5 to 40, in particular from 2 to 30, where DE is a common measure of the reducing effect of a polysaccharide compared with dextrose, which has a DE of 100. It is also possible to use maltodextrins with a DE between 3 and 20 and dried glucose syrups with a DE between 20 and 37, and also so-called yellow dextrins and white dextrins with relatively high molecular weights in the range from 2000 to 30 000 g/mol.

The oxidized derivatives of such dextrins are their reaction products with oxidizing agents, which are able to oxidize at least one alcohol function of the saccharide ring to the carboxylic acid function. A product oxidized on the C₆ of the saccharide ring may be particularly advantageous.

Oxydisuccinates and other derivatives of disuccinates, preferably ethylenediamine disuccinate, are also further suitable cobuilders. Here, ethylenediamine N,N′-disuccinate (EDDS) is preferably used in the form of its sodium or magnesium salts. In this connection, preference is also given to glycerol disuccinates and glycerol trisuccinates. Suitable use amounts in zeolite-containing and/or silicate-containing formulations are 3 to 15% by weight.

Further organic cobuilders which can be used are, for example, acetylated hydroxycarboxylic acids or salts thereof, which may also be present in lactone form and which contain at least 4 carbon atoms and at least one hydroxyl group and at most two acid groups.

A further class of substances with cobuilder properties is the phosphonates. These are, in particular, hydroxyalkane- and aminoalkanephosphonates. Among the hydroxyalkanephosphonates, 1-hydroxyethane-1,1-diphosphonate (HEDP) is of particular importance as cobuilder. It is preferably used as the sodium salt, the disodium salt giving a neutral reaction and the tetrasodium salt giving an alkaline reaction (pH 9). Suitable aminoalkanephosphonates are preferably ethylenediaminetetramethylenephosphonate (EDTMP), diethylenetriaminepentamethylenephosphonate (DTPMP) and higher homologs thereof. They are preferably used in the form of the neutrally reacting sodium salts, e.g. as the hexasodium salt of EDTMP or as the hepta- and octasodium salt of DTPMP. Here, preference is given to using HEDP as builder from the class of phosphonates. In addition, the aminoalkanephosphonates have a marked heavy metal-binding capacity. Accordingly, particularly if the agents also comprise bleaches, it may be preferable to use aminoalkanephosphonates, in particular DTPMP, or mixtures of said phosphonates.

In addition to the substances from the cited classes of substances, the products according to the invention can comprise further customary ingredients of cleaning compositions, where bleaches, bleach activators, enzymes, dyes and fragrances in particular are of importance. These substances are described below.

Among the compounds, which serve as bleaches and liberate H₂O₂ in water, sodium perborate tetrahydrate and sodium perborate monohydrate are of particular importance. Examples of further bleaches, which may be used, are sodium percarbonate, peroxypyrophosphates, citrate perhydrates and H₂O₂-supplying peracidic salts or peracids, such as perbenzoates, peroxyphthalates, diperazelaic acid, phthaloiminoperacid or diperdodecanedioic acid. Laundry or cleaning products according to the invention can also comprise bleaches from the group of organic bleaches. Typical organic bleaches are the diacyl peroxides, such as, for example, dibenzoyl peroxide. Further typical organic bleaches are the peroxy acids, particular examples being the alkylperoxy acids and the arylperoxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid [phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyl-di(6-aminopercaproic acid) can be used.

Bleaches, which may be used in the cleaners according to the invention for machine dishwashing, may also be substances, which liberate chlorine or bromine. Among the suitable materials which liberate chlorine or bromine, are for example heterocyclic N-bromamides and N-chloramides, for example trichloroisocyanuric acid, tribromoisocyanuric acid, dibromoisocyanuric acid and/or dichloroisocyanuric acid (DICA) and/or salts thereof with cations such as potassium and sodium. Hydantoin compounds, such as 1,3-dichloro-5,5-dimethylhydantoin, are likewise suitable.

Bleach activators assist the action of the bleaches. Known bleach activators are compounds, which contain one or more N— or O-acyl groups, such as substances from the class of anhydrides, of esters, of imides and of acylated imidazoles or oximes. Examples are tetraacetyl ethylenediamine TAED, tetraacetyl methylenediamine TAMD and tetraacetyl hexylenediamine TAHD, but also pentaacetyl glucose PAG, 1,5-diacetyl-2,2-dioxohexahydro-1,3,5-triazine DADHT and isatoic anhydride ISA.

Bleach activators, which can be used are compounds which, under perhydrolysis conditions, produce aliphatic peroxycarboxylic acids having preferably 1 to 10 carbon atoms, in particular 2 to 4 carbon atoms, and/or optionally substituted perbenzoic acid. Substances, which carry O-acyl and/or N-acyl groups of said number of carbon atoms and/or optionally substituted benzoyl groups, are suitable. Preference is given to polyacylated alkylenediamines, in particular tetraacetyl ethylenediamine (TAED), acylated triazine derivatives, in particular 1,5-diacetyl-2,4-dioxohexahydro-1,3,5-triazine (DADHT), acylated glycolurils, in particular tetraacetyl glycoluril (TAGU), N-acylimides, in particular N-nonanoyl succinimide (NOSI), acylated phenolsulfonates, in particular n-nonanoyl- or isononanoyloxybenzenesulfonate (n- or iso-NOBS), carboxylic acid anhydrides, in particular phthalic anhydride, acylated polyhydric alcohols, in particular triacetin, ethylene glycol diacetate, 2,5-diacetoxy-2,5-dihydrofuran, n-methylmorpholinium acetonitrile methylsulfate (MMA), and enol esters and acetylated sorbitol and mannitol or mixtures thereof (SORMAN), acylated sugar derivatives, in particular pentaacetyl glucose (PAG), pentaacetyl fructose, tetraacetyl xylose and octaacetyl lactose, and acetylated, optionally N-alkylated, glucamine and gluconolactone, and/or N-acylated lactams, for example N-benzoyl caprolactam. Hydrophilically substituted acyl acetals and acyl lactams are likewise preferably used. Combinations of conventional bleach activators can also be used.

In addition to the conventional bleach activators, or instead of them, so-called bleach catalysts may also be incorporated into the inventive agents. These substances are bleach-boosting transition metal salts or transition metal complexes, such as, for example, Mn—, Fe—, Co—, Ru— or Mo-salen complexes or -carbonyl complexes. Mn—, Fe—, Co—, Ru—, Mo—, Ti—, V— and Cu-complexes with N-containing tripod ligands, and Co—, Fe—, Cu— and Ru-ammine complexes can also be used as bleach catalysts.

Preference is given to using bleach activators from the group of polyacylated alkylenediamines, in particular tetraacetyl ethylenediamine (TAED), N-acylimides, in particular N-nonanoyl succinimide (NOSI), acylated phenolsulfonates, in particular n-nonanoyl- or isononanoyloxybenzenesulfonate (n- or iso-NOBS), n-methylmorpholinium acetonitrile methylsulfate (MMA), preferably in amounts up to 10% by weight, in particular 0.1% by weight to 8% by weight, particularly 2 to 8% by weight and particularly preferably 2 to 6% by weight, based on the total agent.

Bleach-boosting transition metal complexes, in particular with the central atoms Mn, Fe, Co, Cu, Mo, V, Ti and/or Ru, preferably chosen from the group of manganese and/or cobalt salts and/or complexes, particularly preferably the cobalt(ammine) complexes, cobalt(acetato) complexes, cobalt(carbonyl) complexes, the chlorides of cobalt or manganese, of manganese sulfate are used in customary amounts, preferably in an amount up to 5% by weight, in particular from 0.0025% by weight to 1% by weight and particularly preferably from 0.01% by weight to 0.25% by weight, in each case based on the total agent. However, in special cases, more bleach activator can also be used.

To increase their washing or cleaning power, laundry or cleaning agents can comprise enzymes, in principle any enzyme established for these purposes in the prior art being useable. Among these belong proteases, amylases, lipases, cutinases, hemicellulases, cellulases or oxidoreductases, and preferably their mixtures. In principle, these enzymes are of natural origin; improved variants based on the natural molecules are available for use in laundry or cleaning products and accordingly they are preferred. The agents according to the invention preferably comprise enzymes in total quantities of 1×10⁻⁶ to 5 weight percent based on active protein. The protein concentration can be determined using known methods, for example the BCA Process (bicinchoninic acid; 2,2′-biquinolyl4,4′-dicarboxylic acid) or the biuret process.

Preferred proteases are those of the subtilisin type. Examples of these are subtilisins BPN′ and Carlsberg, the protease PB92, the subtilisins 147 and 309, the alkaline protease from Bacillus lentus, subtilisin DY and those enzymes of the subtilases no longer however classified in the stricter sense as subtilisines thermitase, proteinase K and the proteases TW3 und TW7. Subtilisin Carlsberg in further developed form is available under the trade name Alcalase® from Novozymes A/S, Bagsvaerd, Denmark. Subtilisins 147 and 309 are commercialized under the trade names Esperase® and Savinase® by the Novozymes company. Variants derived from the protease from Bacillus lentus DSM 5483, are especially those commercialized as BLAP®.

Further useable proteases are, for example, those enzymes available with the trade names Durazym®, Relase®, Everlase®, Nafizym, Natalase®, Kannase® and Ovozymes® from the Novozymes Company, those under the trade names Purafect®, Purafect® OxP and Properase® from Genencor, that under the trade name Protosol® from Advanced Biochemicals Ltd., Thane, India, that under the trade name Wuxi® from Wuxi Snyder Bioproducts Ltd., China, those under the trade names Proleather® and Protease P® from Amano Pharmaceuticals Ltd., Nagoya, Japan, and that under the designation Proteinase K-16 from Kao Corp., Tokyo, Japan.

Examples of further useable amylases according to the invention are the α-amylases from Bacillus licheniformis, from B. amyloliquefaciens and from B. stearothermophilus, as well as their improved further developments for use in detergents. The enzyme from B. licheniformis is available from the Novozymes Company under the name Termamyl® and from the Genencor Company under the name Purastar®ST. Further development products of this α-amylase are available from the Novozymes Company under the trade names Duramyl® and Termamyl®ultra, from the Genencor Company under the name Purastar® OxAm and from Daiwa Seiko Inc., Tokyo, Japan as Keistase®. The α-amylase from B. amyloliquefaciens is commercialized by the Novozymes Company under the name BAN®, and derived variants from the α-amylase from B. stearothermophilus under the names BSG® and Novamyl® also from the Novozymes Company.

Moreover, for these purposes, attention should be drawn to the α-amylase from Bacillus sp. A 7-7 (DSM 12368) and the cyclodextrin-glucanotransferase (CGTase) from B. agaradherens (DSM 9948); similarly, the fusion products of the cited molecules are suitable.

Moreover, further developments of α-amylase from Aspergillus niger und A. oryzae available from the Company Novozymes under the trade name Fungamyl® are suitable. Further suitable commercial products are, for example Amylase-LT®.

The laundry or cleaning agents can comprise lipases or cutinases, particularly due to their triglyceride cleaving activities, but also in order to produce in situ peracids from suitable preliminary steps. These include, for example, the available or further developed lipases originating from Humicola lanuginosa (Thermomyces lanuginosus), particularly those with the amino acid substitution D96L. They are commercialized, for example by the Novozymes Company under the trade names Lipolase®, Lipolase®Ultra, LipoPrime®, Lipozyme® and Lipex®. Moreover, suitable cutinases, for example are those that were originally isolated from Fusarium solani pisi and Humicola insolens. Likewise useable lipases are available from the Amano Company under the designations Lipase CE®, Lipase P®, Lipase B®, and Lipase CES®, Lipase AKG®, Bacillis sp. Lipase®, Lipase AP®, Lipase M-AP® and Lipase AML®. Suitable lipases or cutinases whose starting enzymes were originally isolated from Pseudomonas mendocina und Fusarium solanii are, for example, available from Genencor Company. Further important commercial products that may be mentioned are the commercial preparations M1 Lipase® und Lipomax® originally from Gist-Brocades Company, and the commercial enzymes from the Meito Sangyo K K Company, Japan under the names Lipase MY-30®, Lipase OF® and Lipase PL® as well as the product Lumafast® from Genencor Company.

Washing or cleaning products, particularly when they are destined for treating textiles, can comprise cellulases, according to their purpose, as pure enzymes, as enzyme preparations, or in the form of mixtures, in which the individual components advantageously complement their various performances. Among these aspects of performance are particular contributions to primary washing performance, to secondary washing performance of the product, (anti-redeposition activity or inhibition of graying) and softening or brightening (effect on the textile), through to performing a “stone washed” effect.

A usable, fungal endoglucanase(EG)-rich cellulase preparation, or its further developments are offered by the Novozymes Company under the trade name Celluzyme®. The products Endolase® and Carezyme® based on the 50 kD-EG, respectively 43 kD-EG from H. insolens DSM 1800 are also obtainable from Novozymes Company. Further commercial products from this company are Cellusoft® and Renozyme®. The 20 kD-EG cellulase from Melanocarpus, obtainable from AB Enzymes Company, Finland under the trade names Ecostone® and Biotouch, can also be used. Further commercial products from the AB Enzymes Company are Econase® and Ecopulp®. A further suitable cellulase from Bacillus sp. CBS 670.93 is obtainable from the Genencor Company under the trade name Puradax®. Additional commercial products from the Genencor Company are “Genencor detergent cellulase L” and Indiage®Neutra.

The washing or cleaning agents can comprise additional enzymes especially for removing specific problem stains and which are summarized under the term hemicellulases. These include, for example mannanases, xanthanlyases, pectinlyases (=pectinases), pectinesterases, pectatlyases, xyloglucanases (=xylanases), pullulanases und β-glucanases. Suitable mannanases, for example are available under the names Gamanase® and Pektinex AR® from Novozymes Company, under the names Rohapec® B1L from AB Enzymes and under the names Pyrolase® from Diversa Corp., San Diego, Calif., USA. β-Glucanase extracted from B. subtilis is available under the name Cereflo® from Novozymes Company.

To increase the bleaching action, the washing and cleaning agents can comprise oxidoreductases, for example oxidases, oxygenases, katalases, peroxidases, like halo-, chloro-, bromo-, lignin-, glucose- or manganese-peroxidases, dioxygenases or laccases (phenoloxidases, polyphenoloxidases). Suitable commercial products are Denilite® 1 and 2 from the Novozymes Company. Advantageously, additional, preferably organic, particularly preferably aromatic compounds are added that interact with the enzymes to enhance the activity of the relative oxidoreductases (enhancers) or to facilitate the electron flow (mediators) between the oxidizing enzymes and the stains over strongly different redox potentials.

The enzymes used in the washing and cleaning agents either stem originally from microorganisms, such as the species Bacillus, Streptomyces, Humicola, or Pseudomonas, and/or are produced according to known biotechnological processes using suitable microorganisms such as by transgenic expression hosts of the species Bacillus or filamentary fungi.

Purification of the relevant enzymes follows conveniently using established processes such as precipitation, sedimentation, concentration, filtration of the liquid phases, microfiltration, ultrafiltration, mixing with chemicals, deodorization or suitable combinations of these steps.

The enzymes can be added to the washing and cleaning agents in each established form according to the prior art. Included here, for example, are solid preparations obtained by granulation, extrusion or lyophilization, or particularly for liquid agents or agents in the form of gels, enzyme solutions, advantageously highly concentrated, of low moisture content and/or mixed with stabilizers.

Alternatively, all enzymes, both for solid as well as for liquid presentation forms, can be encapsulated, for example by spray drying or extrusion of the enzyme solution together with a preferably natural polymer or in the form of capsules, for example those in which the enzyme is embedded in a solidified gel, or in those of the core-shell type, in which an enzyme-containing core is covered with a water-, air- and/or chemical-impervious protective layer. Further active principles, for example stabilizers, emulsifiers, pigments, bleaches or colorants can be applied in additional layers. Such capsules are made using known methods, for example by vibratory granulation or roll compaction or by fluid bed processes. Advantageously, these types of granulates, for example with an applied polymeric film former are dust-free and as a result of the coating are storage stable.

In addition, it is possible to formulate two or more enzymes together, so that a single granulate exhibits a plurality of enzymatic activities.

A protein and/or enzyme in a washing or cleaning agent can be protected, particularly in storage, against deterioration such as, for example inactivation, denaturation or decomposition, for example through physical influences, oxidation or proteolytic cleavage. An inhibition of the proteolysis is particularly preferred during microbial preparation of proteins and/or enzymes, particularly when the compositions also contain proteases. According to the invention, stabilizers can be added for this purpose.

One group of stabilizers is reversible protease inhibitors. For this, benzamidine hydrochloride, borax, boric acids, boronic acids or their salts or esters are frequently used, above all derivatives with aromatic groups, for example ortho, meta or para substituted phenyl boronic acids, or their salts or esters. Peptide aldehydes, i.e. oligopeptides with a reduced C-terminus, are also suitable. Ovomucoid and leupeptin, among others, belong to the peptidic reversible protease inhibitors; an additional option is the formation of fusion proteins from proteases and peptide inhibitors.

Further enzyme stabilizers are amino alcohols like mono-, di-, triethanol- and -propanolamine and their mixtures, aliphatic carboxylic acids up to C₁₂, such as for example succinic acid, other dicarboxylic acids or salts of the cited acids. End-capped fatty acid amide alkoxylates are also suitable stabilizers.

Lower aliphatic alcohols, but above all polyols such as, for example glycerol, ethylene glycol, propylene glycol or sorbitol are further frequently used enzyme stabilizers. Di-glycerol phosphate also protects against denaturation by physical influences. Similarly, calcium and/or magnesium salts are used, such as, for example calcium acetate or calcium formate.

Polyamide oligomers or polymeric compounds like lignin, water-soluble vinyl copolymers or cellulose ethers, acrylic polymers and/or polyamides stabilize enzyme preparations against physical influences or pH variations. Polymers containing polyamine-N-oxide act simultaneously as enzyme stabilizers and color transfer inhibitors. Other polymeric stabilizers are linear C₈-C₁₈ polyoxyalkylenes. Alkyl polyglycosides can also stabilize the enzymatic components of the inventive agents and in addition, induce them to increase in performance. Crosslinked nitrogen-containing compounds perform a dual function as soil release agents and as enzyme stabilizers.

Reducing agents and antioxidants such as sodium sulfite or reducing sugar increase the stability of enzymes against oxidative decomposition.

The use of combinations of stabilizers is preferred, for example of polyols, boric acid and/or borax, the combination of boric acid or borate, reducing salts and succinic acid or other dicarboxylic acids or the combination of boric acid or borate with polyols or polyamino compounds and with reducing salts. The effect of peptide-aldehyde stabilizers is conveniently increased by the combination with boric acid and/or boric acid derivatives and polyols and still more by the additional effect of divalent cations, such as for example calcium ions.

In the context of the present invention, it is particularly preferred to add liquid formulations of enzymes. According to the invention, it is preferred to introduce the additional enzymes and/or enzyme preparations, preferably solid and/or liquid preparations of protease and or amylase, in amounts of 1 to 5 wt. %, preferably 1.5 to 4.5 wt. % and especially 2 to 4 wt. %, each based on the total agent.

Colorants and fragrances may be added to the washing or cleaning agents in order to improve the aesthetic impression created by the products and to provide the consumer not only with the required performance but also with a visually and sensorially “typical and unmistakable” product. Suitable perfume oils or fragrances include individual perfume compounds, for example synthetic products of the ester, ether, aldehyde, ketone, alcohol and hydrocarbon type. Perfume compounds of the ester type are, for example, benzyl acetate, phenoxyethyl isobutyrate, p-tert.-butylcyclohexyl acetate, linalyl acetate, dimethylbenzyl carbinyl acetate, phenylethyl acetate, linalyl benzoate, benzyl formate, ethylmethylphenyl glycinate, allylcyclohexyl propionate, styrallyl propionate and benzyl salicylate. The ethers include, for example, benzyl ethyl ether; the aldehydes include, for example, the linear alkanals containing 8 to 18 carbon atoms, citral, citronellal, citronellyloxyacetaldehyde, cyclamen aldehyde, hydroxycitronellal, lilial and bourgeonal; the ketones include, for example, the ionones, α-isomethyl ionone and methyl cedryl ketone; the alcohols include anethol, citronellol, eugenol, geraniol, linalool, phenylethyl alcohol and terpineol and the hydrocarbons include, above all, the terpenes, such as limonene and pinene. However, mixtures of various perfumes, which together produce an attractive perfume note, are preferably used. Perfume oils such as these may also contain natural perfume mixtures obtainable from vegetal sources, for example pine, citrus, jasmine, patchouli, rose or ylang-ylang oil. Also suitable are muscatel oil, oil of sage, camomile oil, clove oil, melissa oil, mint oil, cinnamon leaf oil, lime blossom oil, juniper berry oil, vetivert oil, olibanum oil, galbanum oil and ladanum oil and orange blossom oil, neroli oil, orange peel oil and sandalwood oil.

The fragrances may be directly incorporated in the agents, although it can also be of advantage to apply the fragrances on carriers, which reinforce the adsorption of the perfume on the washing and thereby ensuring a long-lasting fragrance on the textiles by decreasing the release of the fragrance. Suitable carrier materials have proved to be for example, cyclodextrins, the cyclodextrin/perfume complexes optionally being coated with other auxiliaries.

In order to improve their aesthetic impression, the washing or cleaning agents (or parts thereof may be colored with suitable colorants. Preferred colorants, which are not difficult for the expert to choose, have high storage stability, are not affected by the other ingredients of the detergents or by light and do not have any pronounced substantivity for the substrates being treated, such as glass, ceramics or plastic tableware, so as not to color them.

The washing or cleaning agents may contain derivatives of diaminostilbene disulfonic acid or alkali metal salts thereof as optical brighteners. Suitable optical brighteners are, for example, salts of 4,4′-bis-(2-anilino-4-morpholino-1,3,5-triazinyl-6-amino)stilbene-2,2′-disulfonic acid or compounds of similar structure which contain a diethanolamino group, a methylamino group and anilino group or a 2-methoxyethylamino group instead of the morpholino group. Brighteners of the substituted diphenylstyryl type, for example alkali metal salts of 4,4′-bis-(2-sulfostyryl)diphenyl, 4,4′-bis(4-chloro-3-sulfostyryl)diphenyl or 4-(4-chlorostyryl)-4′-(2-sulfostyryl)diphenyl, may also be present. Mixtures of the brighteners mentioned may also be used.

The process end products of the process according to the invention can be mixed with not only particulate washing or cleaning products, but can also be used in washing or cleaning agent tablets. Surprisingly, the solubility of such tablets is improved by the addition of process end products of the process according to the invention, in comparison to identically compounded tablets of the same hardness, which do not contain any end products of the inventive process. Accordingly, a further subject of the present invention is the use of process end products of the process according to the invention for the manufacture of washing agents, particularly washing agent tablets.

The manufacture of such tablets with the addition of the inventive process end products is described below.

The manufacture of washing and cleaning active moldings occurs by the use of pressure on a mixture to be compressed, which is placed in the cavity of a press. In the simplest case of the molding manufacture, which in the following is simply called tableting, the mixture being tabletted is directly compressed, i.e. without pre-granulating. The advantages of this so-called direct tableting are its simple and cost effective utilization, as no further process steps and consequently no additional equipment is required. Against these advantages are disadvantages, however. Thus, a powder mixture, which is to be directly tabletted, must have sufficient plastic moldability and possess good flow properties; in addition it must not show any tendency to separate during storage, transport or mold filling. These three prerequisites are extraordinarily difficult to control for many substances, and thus direct tableting is not often used—particularly for the manufacture of washing and cleaning agent tablets. The usual method for manufacturing washing and cleaning agent tablets therefore starts with powdered components (“primary particles”), which are agglomerated or granulated by means of suitable processes to secondary particles having higher particle diameters. These granules or mixtures of different granules are then mixed with individual powdered additives and conveyed to the tableting. In the context of the present invention, this means that the process end products of the inventive process are worked up into a premix with further ingredients, which can also be in granular form.

Before compressing the particulate premix into the washing and cleaning agent moldings, the premix can be “dusted” with finely divided surface modifiers. This can be advantageous for the consistency and physical properties of both the premix (storage, compression) and the finished washing and cleaning agent moldings. Finely divided dusting materials are well known from the prior art, zeolites, silicates or other inorganic salts mostly being used. However, the premix is preferably “dusted” with finely divided zeolite, preferably with zeolites of the faujasite type. In the context of the present invention, the term “zeolite of the faujasite type” characterizes all three zeolites, which form the faujasite subgroup of the zeolite structural group 4. (see Donald W. Breck, “Zeolite Molecular Sieves”, John Wiley & Sons, New York, London, Sydney, Toronto, 1974, page 92). Zeolite Y and faujasite as well as their mixtures can also be added besides zeolite X, pure zeolite X being preferred.

Mixtures or cocrystallizates of zeolites of the faujasite type with other zeolites, which do not necessarily belong to the zeolite structural group 4, can be used as dusting agents, it being advantageous if at least 50 wt. % of the dusting agent consists of a zeolite of the faujasite type.

In the context of the present invention, washing and cleaning agent moldings are preferred, which consist of a particulate premix comprising granular components and subsequently mixed-in powdered materials, wherein the, or one of the subsequently mixed-in powdered components is a zeolite of the faujasit type having a particle size below 100 μm, preferably below 10 μm and particularly below 5 μm, and which makes up at least 0.2 wt. %, preferably at least 0.5 wt. % and particularly more than 1 wt. % of the premix being pressed.

In addition to the end products of the process according to the invention, the particulate premix being pressed can further comprise one or more substances from the group of bleaches, bleach activators, enzymes, pH modifiers, fragrances, perfume carriers, fluorescers, dyes, foam inhibitors, silicone oils, anti-redeposition agents, optical brighteners, graying inhibitors, color transfer inhibitors, and corrosion inhibitors. These substances were described previously.

The moldings according to the invention are manufactured first of all by dry-mixing the constituents, some or all of which may have been pregranulated, and subsequently shaping the dry mixture, in particular by compression to tablets, in which context it is possible to have recourse to conventional processes. To produce the moldings according to the invention, the premix is compacted in a so-called die between two punches to form a solid compact. This operation, which is referred to below for short as tableting, is divided into four sections: metering, compaction (elastic deformation), plastic deformation, and ejection.

First of all, the premix is introduced into the die, the fill level and thus the weight and form of the resulting tablet being determined by the position of the lower punch and by the shape of the compression tool. Even in the case of high tablet throughputs, constant metering is preferably achieved by volumetric metering of the premix. In the subsequent course of tableting, the upper punch contacts the premix and is lowered further in the direction of the lower punch. In the course of this compaction, the particles of the premix are pressed closer to one another, with a continual reduction in the void volume within the filling between the punches. When the upper punch reaches a certain position (and thus when a certain pressure is acting on the premix), plastic deformation begins, in which the particles coalesce and the tablet is formed. Depending on the physical properties of the premix, a portion of the premix particles is also crushed and at even higher pressures, there is sintering of the premix. With an increasing compression rate, i.e., high throughputs, the phase of elastic deformation becomes shorter and shorter, with the result that the tablets formed may have larger or smaller voids. In the final step of tableting, the finished tablet is ejected from the die by the lower punch and conveyed away by means of downstream transport means. At this point in time, it is only the weight of the tablet which has been ultimately defined, since the compacts may still change their form and size as a result of physical processes (elastic relaxation, crystallographic effects, cooling, etc).

Tableting takes place in customary commercial tableting presses, which may in principle be equipped with single or double punches. In the latter case, pressure is built up not only using the upper punch; the lower punch as well moves toward the upper punch during the compression operation, while the upper punch presses downward. For small production volumes it is preferred to use eccentric tableting presses, in which the punch or punches is or are attached to an eccentric disk, which in turn is mounted on an axle having a defined speed of rotation. The movement of these compression punches is comparable with the way in which a customary four-stroke engine works. Compression can take place with one upper and one lower punch, or else a plurality of punches may be attached to one eccentric disk, the number of die bores being increased correspondingly. The throughputs of eccentric presses vary, depending on model, from several hundred up to a maximum of 3000 tablets per hour.

For greater throughputs, the apparatus chosen comprises rotary tableting presses, in which a relatively large number of dies is arranged in a circle on a so-called die table. Depending on the model, the number of dies varies between 6 and 55, larger dies also being commercially available. Each die on the die table is allocated an upper punch and a lower punch, it being possible again for the compressive pressure to be actively built up by the upper punch or lower punch only, or else by both punches. The die table and the punches move around a common, vertical axis, and during rotation the punches, by means of rail-like cam tracks, are brought into the positions for filling, compaction, plastic deformation, and ejection. At those sites where considerable raising or lowering of the punches is necessary (filling, compaction, ejection), these cam tracks are assisted by additional low-pressure sections, low-tension rails, and discharge tracks. The die is filled by way of a rigid supply means, known as the filling shoe, which is connected to a stock vessel for the premix. The compressive pressure on the premix can be adjusted individually for upper punch and lower punch by way of the compression paths, the build up of pressure taking place by the rolling movement of the punch shaft heads past displaceable pressure rolls.

In order to increase the throughput, rotary presses may also be provided with two filling shoes, in which case only one half-circle need be traveled to produce one tablet. For the production of two-layer and multilayer tablets, a plurality of filling shoes is arranged in series, and the gently pressed first layer is not ejected before further filling. By means of an appropriate process regime it is possible in this way to produce laminated tablets and inlay tablets as well, having a construction like that of an onion skin, where in the case of the inlay tablets the top face of the core or of the core layers is not covered and therefore remains visible. Rotary tableting presses can also be equipped with single or multiple tools, so that, for example, an outer circle with 50 bores and an inner circle with 35 bores can be used simultaneously for compression. The throughputs of modern rotary tableting presses reach more than a million tablets per hour.

When tableting with rotary presses, it has been found advantageous to perform tableting with minimal fluctuations in tablet weight. Fluctuations in tablet hardness can also be reduced in this way. Low variations in weight can be achieved as follows:
use of plastic inserts with small thickness tolerances
low rotor speed
large filling shoes
harmonization between the filling shoe wing rotary speed and the speed of the rotor
filling shoe with constant powder level
decoupling of filling shoe and powder charge

To reduce caking on the punches, all of the anti-adhesion coatings known from the art are available. Polymer coatings, plastic inserts or plastic punches are particularly advantageous. Rotating punches have also been found advantageous, in which case, where possible, upper punch and lower punch should be of rotatable configuration. In the case of rotating punches, it is generally possible to do without a plastic insert. In this case, the punch surfaces should be electro polished.

It has also been found that long compression times are advantageous. These times can be established using pressure rails, a plurality of pressure rolls, or low rotor speeds. Since the fluctuations in tablet hardness are caused by the fluctuations in the compressive forces, systems should be employed which limit the compressive force. In this case, it is possible to use elastic punches, pneumatic compensators, or sprung elements in the force path. In addition, the pressure roll may be of sprung design.

In the context of the present invention, suitable tableting machines are obtainable, for example, from the following companies: Apparatebau Holzwarth GbR, Asperg, Wilhelm Fette GmbH, Schwarzenbek, Hofer GmbH, Weil, Horn & Noack Pharmatechnik GmbH, Worms, IMA Verpackungssysteme GmbH, Viersen, KILIAN, Cologne, KOMAGE, Kell am See, KORSCH Pressen A G, Berlin, and Romaco GmbH, Worms. Examples of further suppliers are Dr. Herbert Pete, Vienna (AU), Mapag Maschinenbau A G, Berne (CH), B W I Manesty, Liverpool (GB), I. Holland Ltd., Nottingham (GB), Courtoy N. V., Halle (BE/LU), and Medicopharm, Kamnik (SI). A particularly suitable apparatus is, for example, the hydraulic double-pressure press HPF 630 from LAEIS, D. Tableting tools are obtainable, for example, from the following companies: Adams Tablettierwerkzeuge, Dresden, Wilhelm Fett GmbH, Schwarzenbek, Klaus Hammer, Solingen, Herber & Sohne GmbH, Hamburg, Hofer GmbH, Weil, Horn & Noack, Pharmatechnik GmbH, Worms, Ritter Pharmatechnik GmbH, Hamburg, Romaco GmbH, Worms, and Notter Werkzeugbau, Tamm. Further suppliers are, for example, Senss A G, Reinach (CH) and Medicopharm, Kamnik (SI).

The tablets can be produced in predetermined three-dimensional forms and predetermined sizes. Suitable three-dimensional forms are virtually any practicable designs, for example, bar, rod or ingot shaped, cubes, blocks and corresponding three-dimensional elements having planar side faces, and in particular cylindrical designs with a circular or oval cross section. This last design encompasses shapes ranging from tablets through to compact cylinders having a height-to-diameter ratio of more than 1.

In each case, the portioned compacts may be formed as separate, individual elements corresponding to the predetermined dosage of the washing and/or cleaning agent. It is equally possible, however, to design compacts that combine a plurality of such mass units in one compact, with the ease of separation of smaller, portioned units being provided for in particular, by means of predetermined breakage points. For the use of textile laundry detergents in machines of the type customary in Europe, i.e. with a mechanism arranged horizontally, it may be judicious to design the portioned compacts as tablets, in cylindrical or block form, preference being given to a diameter/height ratio in the range from about 0.5:2 to 2:0.5. Commercial hydraulic, eccentric or rotary presses are particularly suitable devices for producing such compacts.

In another embodiment of the tablet, the dimensions of the three-dimensional form are matched to the dispenser drawer of customary commercial household washing machines, so that the tablets can be metered directly into the dispenser drawer without a dosing aid, where they dissolve during the initial rinse cycle. Alternatively, it is of course readily possible, and preferred in the context of the present invention, to use the laundry detergent tablets by way of a dosing aid.

Another preferred tablet which can be produced, has a plate like or bag like structure with alternating, long, thick and short, thin segments, so that individual segments can be broken off from this “slab” at the predetermined breaking points, represented by the short, thin segments and inserted into the machine. This principle of the “slab like” tablet detergent may also be realized in other geometric forms; for example, vertical triangles connected to one another lengthwise at only one of their sides.

However, it is also possible for the various components not to be compressed to a homogeneous tablet, but instead tablets having a plurality of layers, i.e., at least two layers. In this case, it is also possible for these different layers to have different dissolution rates. This may result in advantageous performance properties for the tablets. If, for example, there are components present in the tablets, which have adverse effects on each other, then it is possible to integrate one component into the quicker-dissolving layer and the other component into a slower-dissolving layer, so that the first component has already reacted when the second passes into solution. The layer structure of the tablets may be realized in stack form, in which case dissolution of the inner layer(s) at the edges of the tablet takes place at a point when the outer layers have not yet fully dissolved; alternatively, the inner layer(s) may also be completely enveloped by the respective outer layer(s), which prevents premature dissolution of constituents of the inner layer(s).

In one further, preferred embodiment of the invention, a tablet consists of at least three layers, i.e., two outer and at least one inner layer, with at least one of the inner layers comprising a peroxide bleach, while in the stack-form tablet, the two outer layers, and in the case of the envelope-form tablet, the outermost layers, are free from peroxide bleach. Furthermore, it is also possible to provide spatial separation of peroxide bleach and any bleach activators and/or enzymes present in a tablet. Multilayer tablets of this kind have the advantage that they can be used not only by way of a dispenser drawer or by way of a dosing device, which is placed into the washing liquor; instead, in such cases, it is also possible to place the tablet into the machine in direct contact with the textiles without fear of spotting by bleaches and the like.

Similar effects can also be obtained by coating individual components of the washing and cleaning agent composition being compressed, or of the entire tablet. For this, the tablet being coated can be treated with an aqueous solution or emulsion, or rather obtained by the process of melt-coating an outer layer.

After tableting, the washing and cleaning agent tablets have a high stability. The fracture resistance of cylindrical tablets can be determined through the diametric fracture stress, which in turn may be determined in accordance with the following equation:

$$σ = \frac{2 P}{π D t}$$

where σ stands for the diametric fracture stress (DFS) in Pa, P is the force in N, which leads to the pressure exerted on the tablet, causing it to fracture, D is the tablet diameter in meters and t is the height of the tablet.

As used herein, and in particular as used herein to define the elements of the claims that follow, the articles “a” and “an” are synonymous and used interchangeably with “at least one” or “one or more,” disclosing or encompassing both the singular and the plural, unless specifically defined otherwise. The conjunction “or” is used herein in its inclusive disjunctive sense, such that phrases formed by terms conjoined by “or” disclose or encompass each term alone as well as any combination of terms so conjoined, unless specifically defined otherwise. All numerical quantities are understood to be modified by the word “about,” unless specifically modified otherwise or unless an exact amount is needed to define the invention over the prior art.

1. A process for making detergent granules having a bulk density of 300 to 700 g/l, comprising the steps:
mixing a solid carrier material comprising one or more neutralizing agents with a first portion of a liquid binding agent comprising one or more anionic surfactant acids in a rotating reactor to form a partially granulated premixture;
transferring the premixture to a fluidized bed reactor and fluidizing the premixture to form a fluidized bed;
spraying a second portion of a liquid binding agent comprising one or more anionic surfactant acids onto the fluidized bed in the fluidized bed reactor, and further granulating the premixture to form the detergent granules.

2. The process of claim 1, wherein the rotating reactor is a gravity mixer, drum mixer, tumble mixer, cone mixer, double cone mixer, or V-blender.

3. The process of claim 1, wherein the second portion of liquid binding agent is sprayed onto the fluidized bed at a surface load of 0.0001 to 2.0 kg/(m²s).

4. The process of claim 3, wherein the second portion of liquid binding agent is sprayed onto the fluidized bed at a surface load of 0.001 and 2.0 kg/(m²s).

5. The process of claim 4, wherein the second portion liquid binding agent is sprayed onto the fluidized bed at a surface load of 0.002 and 2.0 kg/(m²s).

6. The process of claim 5, wherein the second portion liquid binding agent is sprayed onto the fluidized bed at a surface load of 0.004 to 2.0 kg/(m²s).

7. The process of claim 1, wherein the fluidized bed has a depth of 2 to 100 cm.

8. The process of claim 7, wherein the fluidized bed has a depth of 4 to 80 cm.

9. The process of claim 8, wherein the fluidized bed has a depth of 8 to 60 cm.

10. The process of claim 9, wherein the fluidized bed has a depth of 10 and 40 cm.

11. The process of claim 1, wherein the second portion of liquid binding agent is sprayed onto the fluidized bed at a volume load of 0.0001 to 6.0 kg/(m³s).

12. The process of claim 1, wherein the second portion of liquid binding agent is sprayed onto the fluidized bed from a distance of at least 10 cm.

13. The process of claim 12, wherein the second portion of liquid binding agent is sprayed onto the fluidized bed from a distance of at least 30 cm.

14. The process of claim 13, wherein the second portion of liquid binding agent is sprayed onto the fluidized bed from a distance of at least 50 cm.

15. The process of claim 1, wherein the sprayed second portion of liquid binding agent comprises droplets having a diameter of 1 to 100 μm.

16. The process of claim 15, wherein the sprayed second portion of liquid binding agent comprises droplets having a diameter of 2 to 80 μm.

17. The process of claim 16, wherein the sprayed second portion of liquid binding agent comprises droplets having a diameter of 4 and 70 μm.

18. The process of claim 17, wherein the sprayed second portion of liquid binding agent comprises droplets having a diameter of 8 and 60 μm.

19. The process of claim 1, wherein the premixture entering into the fluidized bed has a bulk density of 300 to 700 g/l.

20. The process of claim 19, wherein the premixture entering into the fluidized bed has a bulk density of 350 to 650 g/l.

21. The process of claim 20, wherein the premixture entering into the fluidized bed has a bulk density of 400 and 600 g/l.

22. The process of claim 1, wherein the detergent granules have a bulk density of 300 to 700 g/l.

23. The process of claim 22, wherein the detergent granules have a bulk density of 400 to 700 g/l.

24. The process of claim 23, wherein the detergent granules have a bulk density of 500 and 650 g/l.

25. The process of claim 1, wherein the first portion of the liquid binding agent comprises 55 to 90 wt. % of the total added liquid binding agent.

26. The process of claim 1, wherein the granules are subjected to a post treatment after exiting the fluidized bed.
